(19) United States
(12) Patent Application Publication
(10) Pub. No.: US 2026/0254819 A1
(43) Pub. Date: Aug. 27, 2026

(54) DEEP LEARNING APPROACH FOR REAL-TIME SCANNING ATTACK URLS DETECTION USING INNOCENT UNTIL PROVEN GUILTY LEARNING FRAMEWORK (IUPG) AND CUSTOM WEB TRAFFIC VOLUME FEATURES

(71) Applicant: Palo Alto Networks, Inc., Santa Clara, CA (US)

(72) Inventors: Tung-Ling Li, Fremont, CA (US); Brody James Kutt, Irvine, CA (US); Beliz Kaleli, Sunnyvale, CA (US); Fang Liu, College Station, TX (US); Peng Peng, Santa Clara, CA (US); Oleksii Starov, Sunnyvale, CA (US); William Redington Hewlett, II, Mountain View, CA (US)

(21) Appl. No.: 19/062,877

(22) Filed: Feb. 25, 2025

(51) Int. Cl. H04L 9/40

(52) U.S. Cl. CPC H04L 63/1416; H04L 63/0236; H04L 63/029; H04L 63/1425

(57) ABSTRACT

Techniques for a deep learning approach for real-time scanning attack Uniform Resource Locaters (URLs) detection using Innocent Until Proven Guilty (IUPG) learning framework and custom web traffic volume features are disclosed. In some embodiments, a method for a deep learning approach for real-time scanning attack URLs detection using an IUPG learning framework and custom web traffic volume features includes pre-filtering network traffic associated with a URL for an inline scanning attack detection service, determining a plurality of features for the URL, applying the plurality of features for the URL to an IUPG-trained deep learning model for inline detection of scanning URLs, and performing an action in response to a determination that the URL is a scanning URL is disclosed herein.

### BACKGROUND OF THE INVENTION

Malicious actors utilize scanning to detect vulnerabilities in networks and systems. Scanning Uniform Resource Locators (URLs) generally have benign destinations but are crafted to exploit or probe for vulnerabilities of the destinations. Scanning URLS have a high diversity and complexity in their compositions. Thus, it may be difficult to detect new scanning URLs and block their activity on a system or a network.

### BRIEF DESCRIPTION OF THE DRAWINGS

Various embodiments of the invention are disclosed in the following detailed description and the accompanying drawings.

FIG. 1 is a block diagram of a system for detecting scanning URLs in accordance with some embodiments.

FIG. 2 is a block diagram of an ML model for detecting scanning URLs in accordance with some embodiments.

FIG. 3 is a flow diagram for a process of detecting scanning URLs in accordance with some embodiments.

FIG. 4 is a flow diagram illustrating a process for returning a URL verdict in accordance with some embodiments.

FIG. 5 provides an illustration of a scanning attack 500 with example scanning URLs in accordance with some embodiments.

FIG. 6 provides examples of scanning URLs 600 in accordance with some embodiments.

FIG. 7 provides examples of prototypes 700 in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A firewall generally protects networks from unauthorized access while permitting authorized communications to pass through the firewall. A firewall is typically a device, a set of devices, or software executed on a device that provides a firewall function for network access. For example, a firewall can be integrated into operating systems of devices (e.g., computers, smart phones, or other types of network communication capable devices). A firewall can also be integrated into or executed as software applications on various types of devices or security devices, such as computer servers, gateways, network/routing devices (e.g., network routers), or data appliances (e.g., security appliances or other types of special purpose devices).

One type of malicious activity that a firewall may detect and block includes scanning attacks which use scanning Uniform Resource Locators (URLs). Scanning is a common and persistent method used by threat actors to identify vulnerabilities in networks and systems. It is crucial to detect these scanning URLs to safeguard networks and systems effectively. Current systems, such as a rule-based signature system, are capable of identifying and capturing many scanning URLs. However, these current systems fall short in some cases due to the high diversity and complexity of URL compositions. Also, because of the high frequency of new vulnerability introduction, signature-based detection is less responsive to new or emerging threats. Such limitations leave many attacks undetected, posing risks to protected networks and systems.

Often times, scanning URLs differentiate from other malicious URLs because they have benign domains. Current approaches for detecting scanning URLs using machine learning (ML) methods use a URL classifier which may be generally used for all malicious URLs. However, because scanning URLs are often associated with benign domains, the effectiveness of detecting scanning URLs using a general URL classifier is hindered. Specifically, general URL classifiers often generate numerous false positives (e.g., labelling a URL as a scanning URL when it is a safe URL). Furthermore, current systems may fail to detect new malicious URLs that are not represented in the training data.

A technique involving ML methods to detect and classify scanning URLs is disclosed herein. The technique disclosed herein utilizes deep learning techniques and customized features to classify scanning URLs. The techniques disclosed herein expand the ability of security systems to detect both simple and sophisticated scanning URLs. Furthermore, the coverage of a security system employing the techniques disclosed herein is greatly expanded and the ability to detect new malicious URLs not represented in the training data is enhanced.

A URL is received. The network traffic associated with the URL is filtered for use in an inline scanning attack detection service. Features associated with the URL are determined. The features associated with the URL are applied to an Innocent Until Proven Guilty trained (IUPG-trained) deep learning model for inline detection of scanning URLs. In response to a determination that the URL is a scanning URL, an action is performed.

The nature of the IUPG-trained deep learning model allows for enhanced detection of malicious URLs that are not represented in the training data. Enhanced detection derives from the features, the model architecture, the use of IUPG-training methods, and the developed training data. The techniques disclosed herein are also efficient from a computational resource perspective and a speed perspective. This allows for rapid inline detection of scanning URLs before the scanning URLs successfully identify vulnerabilities.

The techniques disclosed herein have been shown to improve scanning URL detection by up to 80% on current solutions with a decrease in the rate of false positives. Furthermore, the technique disclosed herein is lightweight and efficient enough for practical real-time use, thus inline detection is made possible.

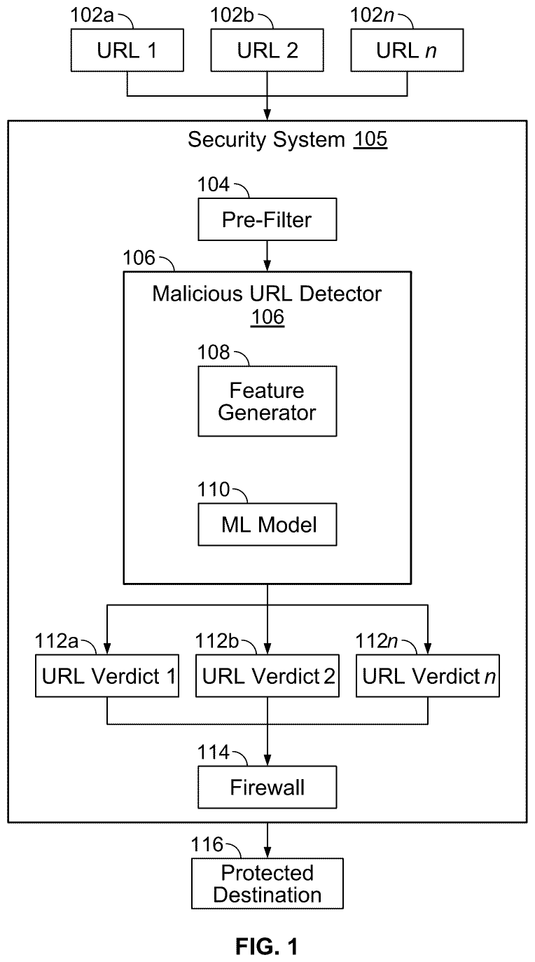

FIG. 1 is a block diagram of a system for detecting scanning URLs in accordance with some embodiments. Malicious URL detector 106 provides security system 105 with the ability to detect scanning URLs. Security system 105 may comprise firewall 114 which is enhanced by URL verdicts 112a, 112b, . . . 112n on URLs 102a, 102b, . . . 102n such that when it is determined that URL 102n is malicious, it is blocked by firewall 114. Malicious URL detector 106 comprises feature generator 108 and ML model 110. Feature generator 108 generates features associated with URLs 102n for inference on ML model 110.

Each of URLs 102a, 102b, . . . 102n may be any URL from which network traffic may be exchanged with security system 105 and/or protected destination 116. In some embodiments, URL 102n is a malicious URL. In some embodiments, URL 102n is a scanning URL which sends network traffic to security system 105 in order to find exploits in security system 105 and/or the networks/systems that are being protected by security system 105 (e.g., protected destination 116). The network traffic may be comprised of the actual URL 102n. In some embodiments, URL 102n is associated with an HTTP request (e.g., GET, POST, PULL, etc.). However, given the nature of the scanning attack, simply receiving URL 102n may be a security risk.

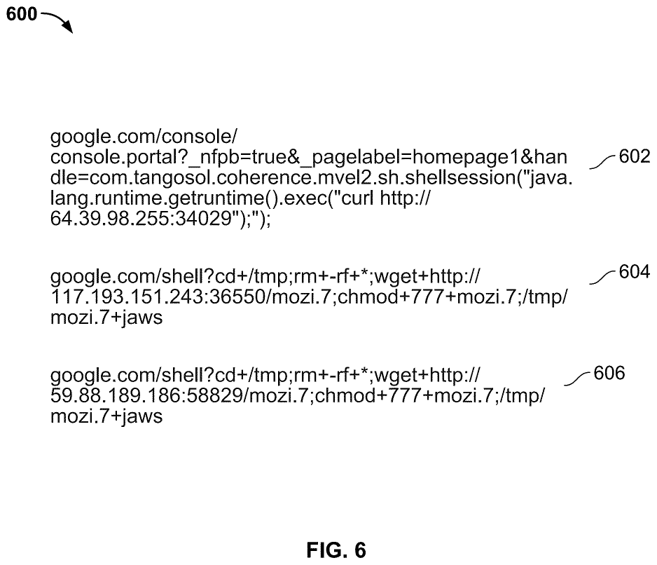

Generally, URLs are structured and contain typical elements. Elements include the scheme (e.g., “http” or “https”), domain name, port, path, query string, and/or fragments. In legitimate uses, elements such as the query string (e.g., “?search=python&sort=date”) may be used to request information from the endpoint, retrieve a certain page on a web browser, fill out an online form, etc. However, often these elements provide space for malicious actors to provide malicious text that will be readable by the destination receiving the URL and will lead to malicious activity. Examples of scanning URLs with malignant properties are provided in FIG. 6.

Security system 105 is a device that is configured to secure protected destination 116 from any form of cyber-attack. Security system 105 may be any device including servers, a computer, a desktop, a laptop, etc. Security system 105 may also be hosted on the cloud. In some embodiments, security system 105 comprises firewall 114 which is configured to block malicious network traffic from reaching protected destination 116. Security system 105 may comprise a variety of components in order to assist in blocking malicious network traffic from affecting protected destination 116.

Security system 105 may encounter a URL 102n for a number of reasons other than for malicious reasons. This is because URLs are a common method of addressing legitimate network traffic. For example, an external service may be built to interact with protected destination 116. This may be facilitated through the use of the external service's URL. In some embodiments, URL 102n is a legitimate URL that has not been seen before by security system 105 nor protected destination 116. An unseen legitimate URL may be associated with a network traffic exchange that has been requested by protected destination 116. Therefore, it is critical that security system 105 differentiates between legitimate URLs and malicious URLs.

Pre-filter 104 filters URLs 102 1:n which may not require a use on malicious URL detector 106. For example, URL 102a may be a URL that is known to be benign by security system 105 or a URL that is known to be malicious by security system 105.

URLs with known classifications may not need further validation. The administrator of security system 105 (e.g., a cyber security provider) may have a database of known malicious and/or benign URLs. For example, when URL 102a matches a URL in this database, then it may be unnecessary for security system 105 to waste further computational power to determine the security classification of URL 102a. Pre-filter 104 may automatically return URL verdict 112a, because the URL verdict of URL 102a is already known.

Malicious URL detector 106 is configured to receive URLs 102a, 102b, . . . 102n and determine URL verdicts 112a, 112b, . . . , 112n using ML methods. URL verdict 112n may comprise a malicious or benign verdict. In some embodiments, URL verdict 112n may comprise any additional information associated with the URL and/or the verdict (e.g., timestamps, metadata regarding determination, Internet Protocol (IP) addresses associated with a URL, etc.).

Feature generator 108 receives a URL 102n and generates one or more features associated with the URL for use in inference on ML model 110. In some embodiments, features are numerical representations of the URL concerning any metric. Feature generator 108 generates a variety of features including volume features, char related features, token related features, token randomness features, and/or char by word features.

Examples of volume features include the total count of requests logged by a network's firewall, the total count of requests made with a particular path logged by all monitored networks'firewalls, the total count of requests made with a particular path logged by a network's firewall, the total count of requests directed to unique targets (i.e., organizations) logged by a network's firewall, the total count of requests directed to unique targets with a particular path logged by all monitored networks'firewalls, the total count of requests directed to unique targets with a particular path logged by a network's firewalls, the total count of requests directed to unique destination IP addresses with a particular path logged by a network's firewalls, the total count of unique networks where the firewall logged at least one request containing a particular path, the total count of unique signatures matched with the requests logged by a network's firewall (i.e., signature hits), etc.

Each volume feature may comprise one or more statistical measures associated with the feature.

ML model 110 receives one or more features associated with a URL 102n as generated by feature generator 108 and produces a determination comprising whether URL 102n is malicious or benign. In some embodiments, ML model 110 comprises a plurality of samples, a plurality of prototypes, one or more neural networks, one or more fully connected layers, and one or more embeddings.

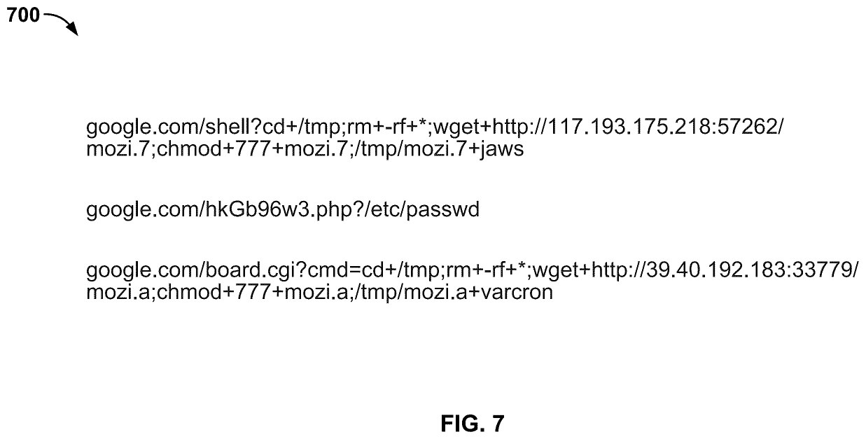

In some embodiments, prototypes are generated by leveraging term frequency-inverse document frequency (TFIDF) and K-means to cluster scanning samples and collect representative samples (cluster centers) of scanning URLs for building prototypes. Prototypes may be described as learnable weights of a linear combination of these representative samples (a basis set) in the embedding space. Examples of prototypes are provided in FIG. 7.

ML model 110 may comprise a variety of different types of neural networks including Convolutional Neural Networks (CNNs) and Kolmogorov-Arnold Networks (KANs). Fully connected layers may be any fully connected link of neural nodes with any activation function tuned with any data.

ML model 110 may be trained using an IUPG framework. An IUPG-training framework is described in more detail below.

Malicious URL detector 106 generates URL verdicts 112a, 112b, . . . 112n which correspond to the URLs which it receives. URL verdict 112n comprises a verdict on the security of status of the URL 102n. The verdict may be scanning URL, non-scanning URL, malicious, benign, etc. URL verdict 102n is sent to firewall 114 where an action (e.g., blocking the URL associated with the verdict) is executed.

In some embodiments, pre-filter 104 generates URL verdict 112n. As discussed, this may occur when the security status is already known and using malicious URL detector 106 on the URL is deemed a waste of computational resources.

Firewall 114 is configured to apply some or all of the security policies determined by security service 105. In some embodiments, when malicious URL detector 106 delivers a malicious URL verdict 112n, firewall 114 implements policies to block the URL associated with the verdict from exchanging network traffic with protected destination 116. In some embodiments, URL verdicts 112 1:n generated by malicious URL detector 106 may be forwarded to one or more firewalls external to security system 105. This may be done to ensure that a malicious URL 102n is blocked from any protected destination 116. For example, a network security provider may send the identity of all detected malicious URLs to all client's security systems.

Protected destination 116 is any device (e.g., a server, computer, desktop, phone, tablet, etc.) or group of devices that may receive network traffic and be vulnerable to malicious activities. Protected destination 116 may comprise a part or a whole of an entity's (e.g., a company, an organization, a government, etc.) computational resources (e.g., cloud server, server, computer, desktop, etc.). In some embodiments, protected destination 116 is a personal device. URLs 102 1:n may be allowed or permitted to interact with protected destination 116 based on the classification of the URL by security system 105 and the application of policies by firewall 114.

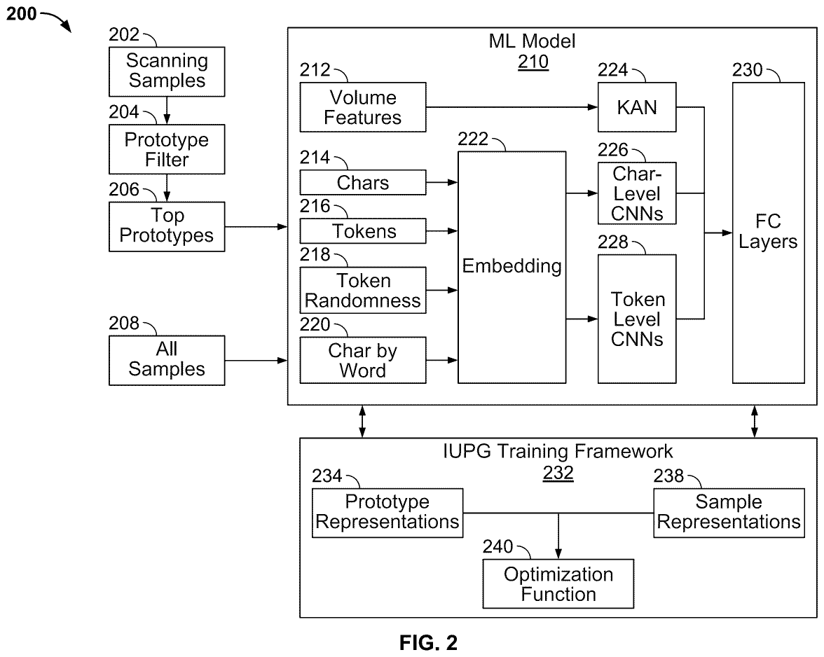

FIG. 2 is a block diagram of an ML system for detecting scanning URLs in accordance with some embodiments. ML system 200 is used to develop ML model 210 which may be deployed on a security system. In some embodiments, ML model 210 is trained such that it may receive a URL and return a verdict regarding whether the URL is malicious or benign. In some embodiments, ML model 210 is trained to detect scanning URLs. Scanning samples 202 are filtered by prototype filter 204 to produce top prototypes 206. Top prototypes 206 and all samples 208 are used to train ML model 210 in conjunction with IUPG training framework 232. In some embodiments, a trained ML model 210 is deployed on a security system.

In various embodiments, training ML model 210 is an iterative process which may occur periodically. In some embodiments, the prototypes and/or samples are modified to include new samples/prototypes. When this occurs ML model 210 may be trained on the newer samples/prototypes.

### Samples and Training Data

Scanning samples 202 comprise a plurality of sample scanning URLs. Scanning samples 202 are collected in order to get a sense of all possible aspects of scanning URLs and may be gathered from previous interactions with malicious scanning URLs. Scanning samples 202 are passed through prototype filter 204 to produce top prototypes 206.

Prototype filter 204 uses ML methods to derive archetypical prototypes of scanning URLs from scanning samples 202. In some embodiments, prototype filter 204 uses TF-IDF and/or K-means clustering.

In some embodiments, TF-IDF (Term Frequency-Inverse Document Frequency) is used to calculate the importance of a sequence of characters in scanning URLs. TF refers to the proportion of a sequence of characters (e.g., “chmod”) divided by the whole URL. IDF is multiplied by TF to weigh down character sequences that occur frequently but are insignificant such as “http://”. This calculation allows the important terms in scanning URLs to be present in the prototypes.

K-means clustering groups similar data points into clusters with the goal of minimizing the distance between the clusters and their respective cluster centroids. In some embodiments, K-means clustering is used in group scanning URLs with similar patterns. Centroids and/or patterns may be associated with host names, domains, paths, content keywords, or any other parts of a URL.

In some embodiments, TF-IDF and K-means clustering is used to retrieve a number of the most representative prototypes (e.g., the top 100 prototypes). These prototypes are top prototypes 206. Top prototypes 206 may be adjusted by adjusting the parameters of determining the top prototypes (e.g., adjusting the parameters of TF-IDF and/or k-means) or determining the number of top prototypes. Top prototypes 206 are used by ML model 210 as training data. Extracting top prototypes 206 is used for the IUPG-training method which will be described in more detail below. Using top prototypes 206 alleviates the capacity of ML model 210 to overfit.

All samples 208 comprise a plurality of URL samples and their classifications as malicious or benign. These samples are also used in training ML model 210. In some embodiments, all samples 208 are generated at least in part from previous encounters with various URLs by a security system.

Examples of prototypes that may be considered top protypes 206 are provided in FIG. 7.

### Machine Learning Model

ML model 210 is trained using top prototypes 206 and all samples 208 in conjunction with IUPG training framework 232. ML model 210 is trained to determine whether URLs are malicious or benign based on the URL and its associated features. A URL's associated features may include volume features 212 and URL-based features including chars 214, tokens 216, token randomness 218, and char by word 220. In some embodiments, ML model 210 comprises four main components: embedding layer 222, CNN layers (char-level CNN 226), the KAN layer for Custom Web Traffic Features, and the Fully Connected Layer.

Volume features 212 may be any feature related to network traffic data associated with a URL. To further illustrate, volume features 212 may relate to logs generated by a device concerning interactions with URLs. Volume features 212 may be generated by manipulating information associated with URL traffic in a variety of different manners (e.g., mathematically, statistically, logically, etc.) to generate a metric that may be used on an ML model. Some results of these manipulations are shown below to illustrate examples of what may be meant by a volume feature.

Included below is a list of example volume features that may be used in the techniques disclosed herein.

### Volume Features List

Volume features 212 include the following list with some explanation where necessary:

Total count of requests logged by a network's firewall. This represents the number of requests made to a particular firewall or set of firewalls (e.g., firewalls in a region). For example, this feature may represent the number of requests associated with a particular URL sent to a U.S. West Coast firewalls.

Total count of requests made with a particular path logged by all monitored networks'firewalls. This represents the number of requests that use a particular path in the URL. An example of a path is site.com/home/contents. This feature is associated with all monitored firewalls. All monitored firewalls may refer to all firewalls monitored by an entity providing cyber security, such as a cyber security company. This feature may be useful in differentiating normal paths such as google.com/home/contents from more abnormal paths.

Total count of requests made with a particular path logged by a network's firewall. This represents the number of requests made by a particular path to a particular firewall or set of particular firewalls (e.g., firewalls in a region, firewalls associated with an entity, firewalls associated with a set of entities, etc.).

The total count of requests directed to unique targets (e.g., entities, companies, governments, organizations, etc.) logged by a network's firewall. This represents the number of requests made to unique targets that may be protected by the same cyber security provider. For example, if a URL sends a request to company A, B, and C then this feature reflects that the URL has sent requests to three unique targets.

The total count of requests directed to unique targets with a particular path logged by all monitored networks'firewalls.

The total count of requests directed to unique targets with a particular path logged by a network's firewalls.

The total count of requests directed to unique destination IP addresses with a particular path logged by a network's firewalls. This feature represents how many requests are sent to certain destinations to a certain IP address. For example, Google™ may have multiple IP addresses for its main website.

The total count of unique networks where the firewall logged at least one request containing a particular path.

The total count of unique signatures matched with the requests logged by a network's firewall (i.e., signature hits). Signatures are associated with a pattern of requests and the strings comprising the URLs. In some embodiments, this is determined using a database of suspicious strings. For example, if a URL sends 100 requests with a string that is deemed malicious, then this feature is 100 for each request sent with a malicious string.

A set of features may comprise statistical metrics associated with each of the features. In some embodiments, statistical metrics involve determining the average values of a feature for a plurality of known URLs and a standard deviation of the feature associated with the URL over a previous period (e.g., n hours or n days). Increasing this look back range may lead to increased computational cost; thus the range n may be manipulatable for engineering requirements. Another statistical metric may be a Boolean value (e.g., 1 or 0) based on whether the feature value for a particular URL is considered abnormal. In some embodiments, a feature value of a URL is considered abnormal when it is a certain number of standard deviations V below or above from the average e.g., the value>V*std. The value V may be changeable. In other words, the Z score is greater than V.

In some embodiments, a moving average and standard deviation for each feature is calculated based on the last n-day traffic volume. Subsequently, these statistics may be used to create a binary indicator (0 or 1) to determine if the feature is abnormal for the URL. For example, if a feature exceeds N standard deviations from the moving average, it is considered abnormal. For further illustration, there may be 27 custom web volume features for each URL (9 features with 3 statistical measurements). According to the previous security research, these features could potentially help identify abnormal or suspicious requests, thus enhancing the ability to discover potential scanning activities. Hence, including these features helps offer ML morel 210 additional information to detect scanning URLs.

The domains in scanning attack URLs typically lack informative value and are benign, thus the domains from URL strings may be removed before passing them to ML model 210 to eliminate unnecessary noise.

The feature set may include the actual value of the feature and any statistical metric associated with the feature for the particular URL.

In some embodiments, the feature set for a URL includes the statistical measures of each feature. For example, if there are 9 features and 3 statistical measures, then each URL will have a feature set of 27 features.

These features may be generated by previous interactions with the particular URL on any networking platform. For example, volume features 212 may be derived from collated network data from a plurality of security systems operated by the same entity (e.g., a cyber security company). Volume features 212 may also be derived from open-source data sets concerning security vulnerabilities.

These features are not intended to limit the techniques disclosed herein and other features may be used in addition to these features with ML model 210.

### KAN

Volume features 212 may be used on Kolmogorov-Arnold Networks (KAN) in order to produce a floating-point vector that may be combined with vectors generated by char level CNNs 226 and token level CNNs 228. This combined vector may be used on Fully Connected (FC) layers 230.

Kolmogorov-Arnold Networks (KANs) are specialized neural networks based on the Kolmogorov-Arnold representation theorem, which asserts that any multivariate continuous function can be decomposed into a finite sum of continuous, univariate functions. In contrast with multilayer perceptrons (MLPs), KANs have learned activation functions as weights on network edges rather than linear weights or activation functions on nodes of the network. KANs have been presented as an alternative to traditional MLPs that can achieve efficient computation and greater interpretability with smaller architectures.

### URL String Features

Chars 214 are the characters of a URL that are passed through embedding 222. Tokens 216 are the individual tokens within a URL. Tokens may be the words inside the URL. For example, the URL “google.com/index.html” may be split into the tokens “google.com” and “index.html”.

Token randomness 218 is calculated and represents the level of randomness of each token using a Hidden Markov Model to estimate character transition probabilities. This feature is encoded as a vector by multiplying a constant vector of 32 floating-point numbers by the randomness score.

The Hidden Markov Model/Markov Chain Model is a statistical model that provides the likelihood of each character following another in the string.

The randomness score may be calculated by first accumulating likelihoods. This is done by accumulating the logarithmic likelihoods of all the character sequences from the Markov Chain Model. To illustrate, if the string is “try”, then it's probability is calculated by calculating Log(probability(“t”,“r”))+Log(probability(“r”,“y”)). Probability(“t”,“r”) means the likelihood that “r” will be after “t”. This probability is derived from a pre-calculated Markov Chain Model. In some embodiments, a particular sequence that is searched has not been calculated in the pre-calculated Markov Chain Model. In this case, we have a default probability, which is 0.00001.

In some embodiments, the randomness score is normalized. This is done to make the score comparable for strings of different lengths. To execute normalization, the total accumulated likelihood is divided by the length of the string. The more negative the score is, the more random the string is.

Char by word 220 is calculated to reflect separate words that comprise the URL. Char by word 220 may be similar to tokens 216. Char by word 220 may be calculated by breaking each token into individual characters and applying the char embedding for each character in the token. The character embeddings are summed up in a token to get the char by word embedding (e.g., char by word 220) for the token.

For example, the token “google” will be broken down into [“g”, “o”, “o”, “g”, “l”, “e”]. We then apply embedding to each character and get the 6×32 embedding vector. We then sum up the embeddings to get a 1×32 char by word embedding for the token “google”.

Each of the URL string features are passed through embedding layer 222 in order to produce embedding vectors. Embedding layer 222 may transform URL string features into vectors of floating-point numbers (e.g., 0.0291239721, 0.012973129, 0.01498792, etc.) for use on char level CNNs 226 and/or token level CNNs 228. Floating point numbers may be used to allow more information to comprise a single space in a vector.

Char level CNNs 226 may be comprised of one or more CNN layers. This may be adjusted for engineering specifications. Similarly, token level CNNs 228 may comprise one or more CNN layers.

As an illustration of this process, first the tokens and characters of the URL string are passed through the embedding layer, which converts each token and character into a vector of 32 floating-point numbers. Additionally, the token randomness 218 of the URL is calculated. If the URL string consists of ten tokens, with five characters for each token, four embedding vectors may be created: token embedding vector (10×32), char embedding vector (50×32), char_by_word embedding vector (10×32), and token randomness embedding vector (10×32). These embedding vectors are then concatenated to create a final token embedding vector of dimensions 30×32.

In some embodiments, the token embedding vector, the token randomness embedding vector, and the char_by_word embedding vector are concatenated into a total token vector, while the char embedding vector is kept as its own vector. In some embodiments, the total token vector is passed through token level CNNs 228 while the char vector is passed through char-level CNNs 226.

The final token embedding vector may be split up in a logical manner for use on different CNNs. In some embodiments, the token embedding vectors (e.g., vectors associated with tokens 216, token randomness 218, and char by word 220) are passed through token level CNNs 228. In some embodiments, the char embedding vector associated with chars 214 is passed through char level CNNs 226. In some embodiments, the token embedding vector may be used on a single CNN.

Each CNN layer may be followed by a global max pooling layer, which retains the maximum value from each filter in the CNN. As an example, this process may generate a vector of 640 floating-point numbers for each CNN. The resulting vectors from both CNN layers may then be concatenated. In this example, the result in a final vector will have a dimension 1335.

As an illustration, suppose there are 36 volume features. KAN 224 may process the 36 volume features to transform them into a vector of 128 floating-point numbers. The vector from the CNNs (e.g., char-level CNNs 226 and Token Level CNNs 228) and the vector from the KAN layer are concatenated and passed through the FC layer. This layer processes and reduces the vector dimension to 1024.

FC layers 230 may be a neural net of one or more layers of fully connected nodes which each use any activation function. The exact specifications of FC layers 230 may be toggled in order to better fit engineering specifications and increase effectiveness of ML model 210. FC layers 230 processes the features produced by KAN 224, char-level CNNs 226, and token level CNNs 228 and produces a verdict on whether a URL is malicious or benign. FC layers 230 may be tuned to determine whether a URL is a malicious scanning URL.

In some embodiments, FC layers 230 is a neural network configured to return a classification on a URL. For example, FC layers 230 may be configured to return a scanning URL classification or a non-scanning URL classification. In some embodiments, this classification is used for a URL verdict.

In some embodiments, FC layers 230 uses feature representations from KAN 224, char level CNNs 226, and/or token level CNNs 228 to calculate an L1 Euclidean Distance of the URL's vectors with one or more prototypes. This L1 Euclidean distance may be used to derive a scanning score. The scanning score may be compared to a threshold value which yields a URL verdict.

In some embodiments, IUPG training framework 232 trains ML model 210 to employ the equivalent distance measurement between data and prototypes in order to determine whether the URL is scanning or non-scanning. After the training, the representations of prototypes will be stored with ML model 210. In inline detection, FC layers 230 receives all features from KAN 224, char level CNNs 226, and/or token level CNNs 228, and produces a representation vector of the URL. Following this, the L1 Euclidean distance method is used to compare the representation vector with the representation vectors of the prototypes. In some embodiments, the scanning score associated with a URL is calculated from using the results of the L1 Euclidean distance method on the representation vectors.

### IUPG Training Framework

ML model 210 may be trained using IUPG training framework 232. IUPG training includes learning a library of inputs within the original input space that, together with the network, prototype uniquely identifiable subsets of the input space. The network learns to map the input space to an output vector space in which prototypes and members of the relevant input subset map exclusively to a common point in the output vector space. The distances between noise (or any class of data lacking a prototypical description) and all prototypes in the output vector space are maximized in training. These noise classes may be called “off-target” while target classes have one or more assigned prototypes. Off-target data helps to chisel down the extracted features of target classes to that which is truly class-exclusive as opposed to coincidental.

IUPG training framework 232 involves leveraging TFIDF and K-means to cluster scanning samples and collect sample representations 238 (cluster centers) of scanning URLs for building prototypes before training.

Sample representations 238 may comprise feature representations of URLs as developed by ML model 210. The URLs may be derived from scanning samples 202, all samples 208, or any other corpus of URL samples. Sample representations 238 comprises the features associated with sample URLs which are known to be scanning URLs and sample URLs which are known to be benign URLs. Furthermore, the labels (e.g., scanning, benign, non-scanning, etc.) of the URL for which the feature representations are associated with may be stored along with scanning samples 238.

Regarding features, sample representations 238 may comprise any feature-based representation of a URL generated by any one or more of the components of ML model 210. Sample representations 238 may comprise feature representations developed by KAN 224 concatenated with char-level CNNs 226 and token level CNNs 228. In some embodiments, sample representations 238 comprises the feature representations generated by KAN 224, char-level CNNs 326, token level CNNs 228, and those generated by FC layers 230.

Prototype representations 234 may be feature representations of URLs that are determined to be prototypical representations of scanning URLs. In some embodiments, prototype representations 234 are feature representations of top prototypes 206. Similar to sample representations 238, prototype representations 234 may be features generated by any one or more components of ML model 210 (e.g., KAN 224, char-level CNNs 226, token level CNNs 228, FC layers 230, and/or embedding 222).

Prototypes may be defined as learnable weights of a linear combination of representative samples (a basis set (e.g., representations of top prototypes 206)) in the embedding space. During training, representations of training samples (e.g., representations of all samples 208) and prototypes may be extracted using char-level CNNs 226, token-level CNNs 228, KAN 224, and/or FC layers 230. In some embodiments, L1 Euclidean distances between the representations of each sample and all prototypes are determined. This may be done using feature representations which comprise sample representations 238 and feature representations which comprise prototype representations 234. This is possible because feature representations may be vectors numbers.

In some embodiments, using the L1 Euclidean distances, a scanning URL score is calculated for each URL of sample representations 238. In some embodiments, the scanning URL score is further calculated using the minimum normalized distance to all prototypes by calculating 1-min(tanh(distances)). The weights used in any component used in ML model 210 may be optimized such that the distances between sample representations 238 which are known to be scanning URLs and prototype representations 234 are closer. Similarly, optimization may be accomplished by adjusting the weights of ML model 210 to ensure that the distances between known non-scanning (e.g., benign URLs) URLs and prototype representations 234 are further apart than the distances between known scanning URLs and prototype representations 234.

Optimization function 240 may be used to execute the optimization discussed above, thus ensuring that the weights of ML model 210 are optimized based on the sample representations 238 and the prototype representations 234. In some embodiments, optimization function 240 comprises the use of the cross-entropy loss optimization function. However, optimization function 240 may be any optimization function, e.g., gradient descent, stochastic gradient descent, mini-batch gradient descent, Adam, AdaGrad, RMSprop, Nesterov accelerated gradient, L-BFGS, momentum, AdaDelta, . . . etc.

This use of the IUPG framework makes the ML model 210 more robust to out-of-distribution content, reducing the likelihood of false positives and allowing for higher recall at ultra-low false positive rates typical of production requirements.

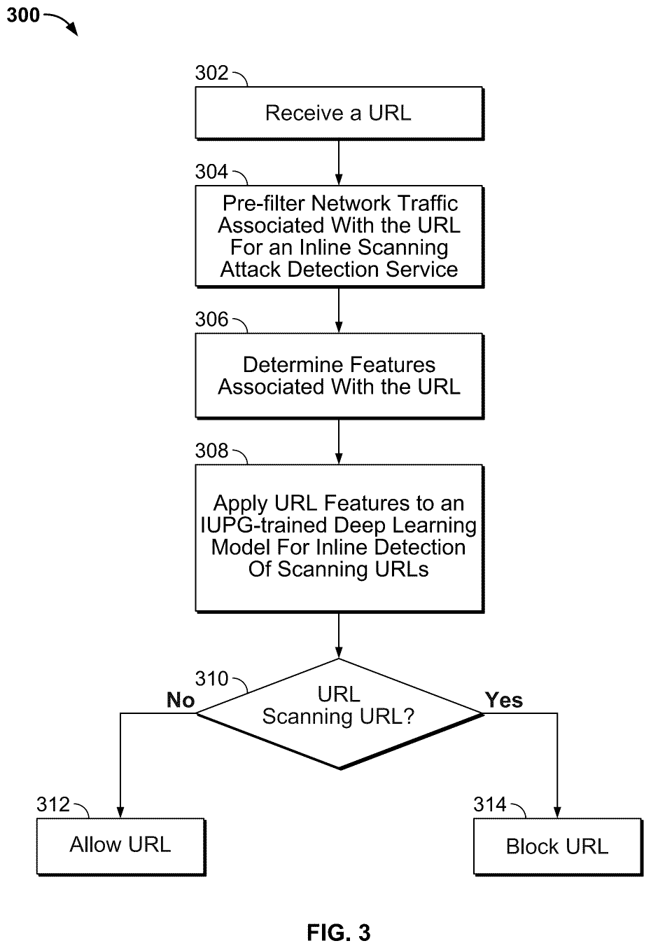

FIG. 3 is a flow diagram for a process of detecting scanning URLs in accordance with some embodiments. Process 300 may be executed by a security system.

At 302, a URL is received. A URL may be received from any device that is sending network traffic to a system executing process 300 such as a computer, a server, a desktop, a phone, a tablet, etc. The URL may be legitimate, malicious, benign, a scanning URL, a non-scanning URL, etc. The URL may be from a malicious party attempting to hack a security system.

At 304, network traffic associated with the URL is pre-filtered for an inline scanning attack detection service. It should be understood that the URL in itself being sent to the security system constitutes network traffic. This is because the URL may be received and processed. When a URL is processed by a destination a scanning attack may occur. In some embodiments, the whole URL is blocked from being further processed by process 300. In some embodiments, this is because pre-filtering detects that the URL is benign, e.g., it is a URL that is seen often and is known to be benign. In some embodiments, the pre-filtering is able to rapidly determine that the URL is malicious, thus, further analysis on the URL may waste computational power. For example, the URL may match a URL in a database that is labelled as malicious. In another example, the URL may be associated with an IP address, port, or other source identifying information, that is known to be malicious. Step 304 is used to relieve computational stress on the downstream inline scanning attack detection service by blocking URLs that can be rapidly deemed malicious or allowing URLs that are known to be benign.

At 306, features associated with the URL are determined. Step 306 may be executed by a feature generator. There are many types of features that may be determined at this step. Example features include one or more of the following: volume features, char features, token features, and token randomness features. The features may be determined using any information acquired or available to the system executing process 300.

At 308, URL features are applied to an IUPG-trained deep learning model for inline detection of scanning URLs. The deep learning model may comprise several components including embeddings, KANs, char-level CNNs, token level CNNs, and FC layers. An IUPG training framework may be used to train the deep learning model. The IUPG training framework may comprise prototype representations, sample representations, and an optimization function. The prototype representations and sample representations may have been determined at a previous time and used to train the model. The IUPG-trained deep learning model produces a URL verdict based on whether the URL is a scanning URL or a non-scanning URL.

At 310, whether or not the URL is a scanning URL is determined. This is determined based on the URL verdict produced in step 308. In response to a determination that the URL is a scanning URL, process 300 proceeds to step 314.

At 314, the URL is blocked. The URL is blocked from accessing the destination protected by a device that is executing process 300. In some embodiments, blocking comprises applying security policies at a firewall. In some embodiments, a firewall is configured to prevent further network traffic from the URL in the future.

In response to a determination that the URL is not a scanning URL, process 300 proceeds to step 312.

At 312, the URL is allowed. The URL may be allowed to access a destination that is protected by a device executing process 300.

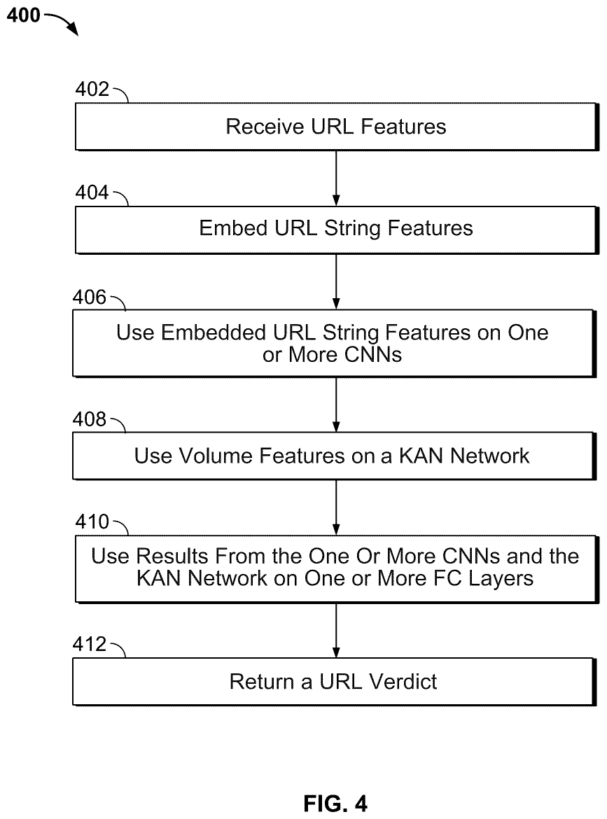

FIG. 4 is a flow diagram illustrating a process for returning a URL verdict in accordance with some embodiments. Process 400 may be executed by a machine learning model. In some embodiments, some or all of process 400 is used to execute step 308.

At 402, features associated with a URL are received. These features include volume features and URL string features. URL string features may be associated with chars, tokens, token randomness features, and/or char by word features.

At 404, the URL string features are embedded. Embedding may occur in any manner known in the arts. Embedding may comprise transforming characters and/or tokens (e.g., words) within the URL into numerical representations of the URL. The result of the embedding is a numerical representation of the string features of a URL stored in a vector. In some embodiments, these numerical representations are floating point numbers such that a maximal amount of information is stored in a small number.

Embedding may produce one or more separate vectors. Examples are a vector representing all independent chars in the URL string, along with a separate vector representing all of the tokens in the URL string, a vector representing char by words, a vector representing token randomness, etc. In some embodiments, these one or more vectors may be concatenated in any manner (e.g., four vectors are concatenated into two vectors, four vectors are concatenated into one vector, or three vectors concatenated into one vector, while one vector remains, etc.).

At 406, the embedded URL string features are used on one or more CNNs. As discussed, the embedded string features may be concatenated in a variety of manners. Likewise, each concatenated vector may be used on one or more CNNs in any manner. For example, the embeddings of the char-related vectors may be concatenated and used on a char-level CNN while the token related vectors may be concatenated and used on a token CNN. Each CNN may comprise one or more CNN layers. The results of each CNN may also be concatenated in any manner.

At 408, volume features are used on a KAN. Volume features may be any feature related to network traffic data associated with a URL. To further illustrate, volume features may relate to logs generated by a device concerning interactions with URLs. Volume features may be generated by manipulating information associated with URL traffic in a variety of different manners (e.g., mathematically, statistically, logically, etc.) to generate a metric that may be used on an ML model. KANs are specialized neural networks based on the Kolmogorov-Arnold representation theorem, which asserts that any multivariate continuous function can be decomposed into a finite sum of continuous, univariate functions.

At 410, the results from the one or more CNNs (from step 406) and the results from the KAN (from step 408) are used on one or more fully connected (FC) layers. In some embodiments, the CNNs and KANs output further feature representations of the URL. These feature representations may be concatenated in any manner and used as a feature vector on one or more FC layers. In some embodiments, FC layers is a neural network configured to return a classification which labels a URL as a scanning URL or a non-scanning URL.

FC layers may be a neural net of one or more layers of fully connected nodes which each use any activation function. The exact specifications of FC layers may be toggled in order to better fit engineering specifications and increase effectiveness of process 400.

At 412, a URL verdict is returned. In some embodiments, the URL verdict is directly associated with a classification returned by the FC layers. For example, if the classification is that the URL is a scanning URL, then the verdict will be that the URL is a scanning URL. This verdict may be used to advise network security policies associated with the URL.

The ML aspects of process 400 including the KAN, the CNNs, and the FC layer may be trained using an IUPG training framework.

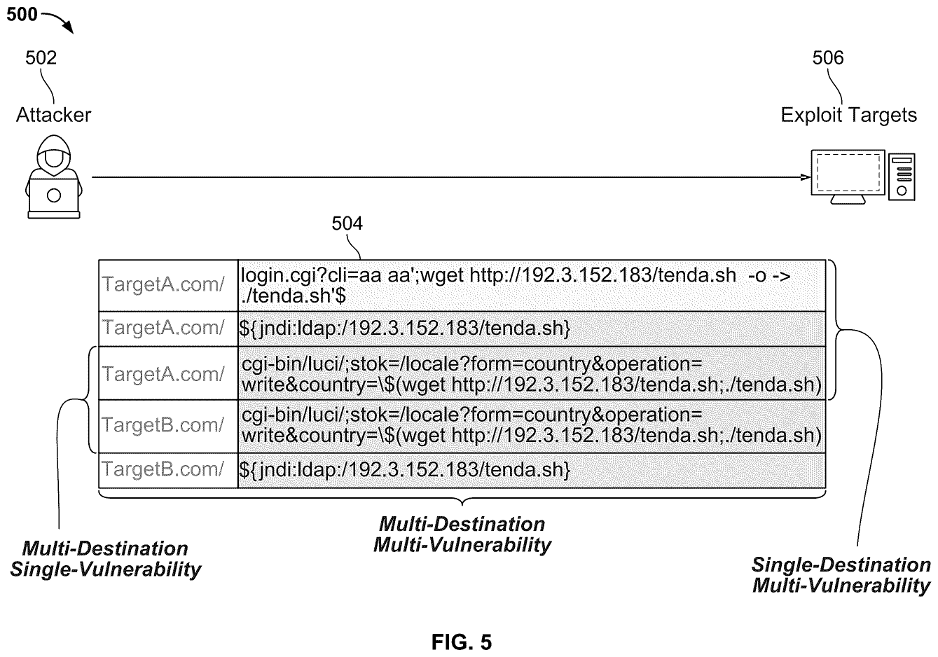

FIG. 5 provides an illustration of a scanning attack 500 with example scanning URLs in accordance to some embodiments. Attacker 502 sends URLs 504 to exploit targets 506. As shown in the figure, scanning URLs 504 may be intended to scan for attacks in multi-destinations (e.g., multiple servers) and/or multi-vulnerability (e.g., comprising of code that can cause multiple attacks. In this example, the techniques disclosed herein may sit between attacker 502 and block URLs 504 from reaching exploit targets 506 when it is determined that URLs 504 are scanning attack URLs.

FIG. 6 provides examples of scanning URLs 600 in accordance with some embodiments. Each of these scanning URLs are detected by the techniques disclosed herein and may be prevented from engaging in malicious activity. URL 602 attempts to send information to a malicious actor using a curl command. URL 604 attempts to open a shell system, navigate through directories, change security policies for files, and retrieve information from a webserver using wget. URL 606 attempts to perform similar malicious activity as URL 604.

FIG. 7 provides examples of prototypes 700 in accordance with some embodiments. The three prototypes provided in FIG. 7 may be used in training an ML model using IUPG-training techniques. In some embodiments, feature representations of these prototypes are generated for use in training an IUPG-trained model.

Although the foregoing embodiments have been described in some detail for purposes of clarity of understanding, the invention is not limited to the details provided. There are many alternative ways of implementing the invention. The disclosed embodiments are illustrative and not restrictive.

WHAT IS CLAIMED IS:

1. A method, comprising:
pre-filtering network traffic associated with a Uniform Resource Locater (URL) for an inline scanning attack detection service;
determining a plurality of features for the URL;
applying the plurality of features for the URL to an Innocent Until Proven Guilty trained (IUPG-trained) deep learning model for inline detection of scanning URLs; and
in response to a determination that the URL is a scanning URL, performing an action.

2. The method of claim 1, wherein applying the plurality of features for the URL to the IUPG-trained deep learning model for inline detection of scanning URLs further comprises:
embedding URL string features;
using the embedded URL string features on one or more Convolutional Neural Network (CNN) models;
using volume features on a Kolmogorov-Arnold Network (KAN) model; and
using results from the one or more CNN models and the KAN model on one or more fully connected (FC) layers to return a URL verdict.

3. The method of claim 1, wherein the plurality of features for the URL include volume features.

4. The method of claim 1, wherein the plurality of features for the URL include string features.

5. The method of claim 1, wherein IUPG-training further comprises using top prototypes.

6. The method of claim 1, wherein the plurality of features for the URL include string features wherein string features comprise token randomness features.

7. The method of claim 1, wherein the plurality of features for the URL include volume features, and wherein the volume features comprise one or more metrics associated with one or more volume features.

8. The method of claim 1, wherein the plurality of features for the URL include volume features, and wherein the volume features comprise a feature representing a total count of requests made with a particular path logged by all monitored networks' firewalls.

9. The method of claim 1, wherein IUPG-training further comprises using top prototypes, and wherein the top prototypes are derived from a plurality of sample URLs through use of machine learning methods.

10. The method of claim 1, wherein IUPG-training further comprises using an optimization function to optimize weights of the IUPG-trained deep learning model by optimizing one or more output feature vectors of sample representations.

11. A system, comprising:
a processor configured to:
pre-filter network traffic associated with a Uniform Resource Locater (URL) for an inline scanning attack detection service;
determine a plurality of features for the URL;
apply the plurality of features for the URL to an Innocent Until Proven Guilty trained (IUPG-trained) deep learning model for inline detection of scanning URLs; and
in response to a determination that the URL is a scanning URL, perform an action; and
a memory communication interface coupled to the processor and configured to provide the processor with instructions.

12. The system of claim 11, wherein applying the plurality of features for the URL to the IUPG-trained deep learning model for inline detection of scanning URLs further comprises:
embedding URL string features;
using the embedded URL string features on one or more Convolutional Neural Network (CNN) models;
using volume features on a Kolmogorov-Arnold Network (KAN) model; and
using results from the one or more CNN models and the KAN model on one or more fully connected (FC) layers to return a URL verdict.

13. The system of claim 11, wherein the plurality of features for the URL include volume features.

14. The system of claim 11, wherein the plurality of features for the URL include string features.

15. The system of claim 11, wherein IUPG-training further comprises using top prototypes.

16. The system of claim 11, wherein the plurality of features for the URL include string features wherein string features comprise token randomness features.

17. The system of claim 11, wherein the plurality of features for the URL include volume features, and wherein the volume features comprise one or more metrics associated with one or more volume features.

18. The system of claim 11, wherein the plurality of features for the URL include volume features, and wherein the volume features comprise a feature representing a total count of requests made with a particular path logged by all monitored networks'firewalls.

19. The system of claim 11, wherein IUPG-training further comprises using top prototypes, and wherein the top prototypes are derived from a plurality of sample URLs through use of machine learning methods.

20. A computer program product embodied in a non-transitory computer readable medium and comprising computer instructions for:
pre-filtering network traffic associated with a Uniform Resource Locater (URL) for an inline scanning attack detection service;
determining a plurality of features for the URL;
applying the plurality of features for the URL to an Innocent Until Proven Guilty trained (IUPG-trained) deep learning model for inline detection of scanning URLs; and
in response to a determination that the URL is a scanning URL, performing an action.
